(19) United States
(12) Patent Application Publication
(10) Pub. No.: US 2025/0326610 A1
(43) Pub. Date: Oct. 23, 2025

(54) PERIMETER MONITORING SYSTEM FOR WORKING MACHINE

(71) Applicant: SUMITOMO HEAVY INDUSTRIES, LTD., Tokyo (JP)

(72) Inventors: Yuki OHIRA, Kanagawa (JP); Taira MATSUOKA, Kanagawa (JP)

(21) Appl. No.: 19/252,473

(22) Filed: Jun. 27, 2025

Related U.S. Application Data
(63) Continuation of application No. PCT/JP2023/046619, filed on Dec. 26, 2023.

(30) Foreign Application Priority Data
Dec. 28, 2022 (JP) 2022-212034

(51) Int. Cl. B66C 13/46; B66C 23/88

(52) U.S. Cl. CPC B66C 13/46; B66C 23/88

(57) ABSTRACT

A perimeter monitoring system for a working machine includes a plurality of object detection devices configured to detect an object in a perimeter of the working machine, and a controller configured to calibrate at least one object detection device detachably attached to the working machine with reference to at least one other object detection device fixed to the working machine, the at least one object detection device and the at least one other object detection device being from among the object detection devices.

### RELATED APPLICATION

This application is a continuation application of International Application No. PCT/JP2023/046619, filed on Dec. 26, 2023, and designated the U.S., which is based upon and claims priority to Japanese Patent Application No. 2022-212034, filed on Dec. 28, 2022, the entire contents of which are incorporated herein by reference.

### TECHNICAL FIELD

The disclosures herein relate to perimeter monitoring systems for working machines.

### BACKGROUND ART

In related arts, working machines are equipped with a plurality of object detection devices such as a plurality of position measurement devices (sensors such as LiDAR) in order to detect objects (people and obstacles) within a warning area.

### SUMMARY

A perimeter monitoring system for a working machine includes a plurality of object detection devices configured to detect an object in a perimeter of the working machine, and a controller configured to calibrate at least one object detection device detachably attached to the working machine with reference to at least one other object detection device fixed to the working machine, the at least one object detection device and the at least one other object detection device being from among the object detection devices.

### BRIEF DESCRIPTION OF THE DRAWINGS

FIG. 1 is a side view of a crane as a working machine according to Embodiment one of the present disclosure;

FIG. 2 is a bottom view of the crane shown in FIG. 1;

FIG. 3 is a block diagram illustrating the perimeter monitoring system of the crane;

FIG. 4 is a drawing illustrating a first example of object measurement using a reference sensor and an optional sensor;

FIG. 5 is a drawing illustrating a second example of object measurement using the reference sensor and the optional sensor;

FIG. 6 is a drawing illustrating a third example of object measurement using the reference sensor and the optional sensor;

FIG. 7 is a drawing illustrating a fourth example of object measurement using the reference sensor and the optional sensor;

FIG. 8 is a flowchart of obstacle detection;

FIG. 9A is a drawing illustrating an example of object measurement using a reference sensor and an optional sensor in Embodiment two of the present disclosure;

FIG. 9B is a drawing illustrating an example of the object measurement using the reference sensor and the optional sensor in Embodiment two of the present disclosure;

FIG. 9C is a drawing illustrating an example of the object measurement using the reference sensor and the optional sensor in Embodiment two of the present disclosure;

FIG. 9D is a drawing illustrating an example of the object measurement using the reference sensor and the optional sensor in Embodiment two of the present disclosure;

FIG. 9E is a drawing illustrating an example of the object measurement using the reference sensor and the optional sensor in Embodiment two of the present disclosure;

FIG. 10 is a flowchart of obstacle detection in Embodiment two of the present disclosure;

FIG. 11A is a drawing illustrating a point group that is a measurement result of the reference sensor;

FIG. 11B is a drawing illustrating a point group that is a measurement result of the reference sensor;

FIG. 12A is a drawing illustrating a point group as a measurement result of the optional sensor;

FIG. 12B is a drawing illustrating a point group as a measurement result of the optional sensor;

FIG. 13 is a drawing illustrating an example of a plurality of object detection devices according to Embodiment three of the present disclosure;

FIG. 14 is a drawing illustrating an example of the plurality of object detection devices according to Embodiment three of the present disclosure;

FIG. 15A is a drawing illustrating an example of the plurality of object detection devices according to Embodiment three of the present disclosure;

FIG. 15B is a drawing illustrating an example of the plurality of object detection devices according to Embodiment three of the present disclosure;

FIG. 15C is a drawing illustrating an example of the plurality of object detection devices according to Embodiment three of the present disclosure;

FIG. 16 is a flowchart of a calibration process according to Embodiment three of the present disclosure;

FIG. 17A is a drawing illustrating an example of a posture change of an object according to Embodiment three of the present disclosure;

FIG. 17B is a drawing illustrating an example of the posture change of the object according to Embodiment three of the present disclosure; and

FIG. 17C is a drawing illustrating an example of a posture change of the object in Embodiment three of the present disclosure.

### DETAILED DESCRIPTION

When using a plurality of object detection devices, calibration to correct detection deviations among the devices is complicated. In addition, since when the position measurement devices are displaced from their initial installation positions (position deviation and/or attitude deviation) due to vibration or impact during operation, detection results of the position measurement devices deviate, and it becomes necessary to correct such deviations to maintain accurate detection.

A first mode of the present disclosure provides a perimeter monitoring system for a working machine capable of readily performing calibration between a plurality of object detection devices. A second mode of the present disclosure provides a perimeter monitoring system for a working machine capable of more readily correcting the deviation of the position measurement devices installed on the working machine.

The perimeter monitoring system for the working machine according to Embodiment two of the present disclosure may include a first position measurement device configured to measure three-dimensional information of the object, and a second position measurement device, which is separate from the first position measurement device, configured to measure three-dimensional information of the object, wherein the first position measurement device is fixed to a first measurement device mounting part of the working machine, the second position measurement device is configured to be attachable to a plurality of positions on the working machine, and the controller includes a processor configured to calibrate a position and an attitude of the second position measurement device with reference to the first position measurement device.

### Embodiment One

Hereinafter, Embodiment one of a perimeter monitoring system for a working machine according to the second mode of the present disclosure will be described in detail with reference to the drawings. The first position measurement device and the second position measurement device described later are examples of a plurality of object detection devices for detecting objects around the working machine.

### Configuration of Crane

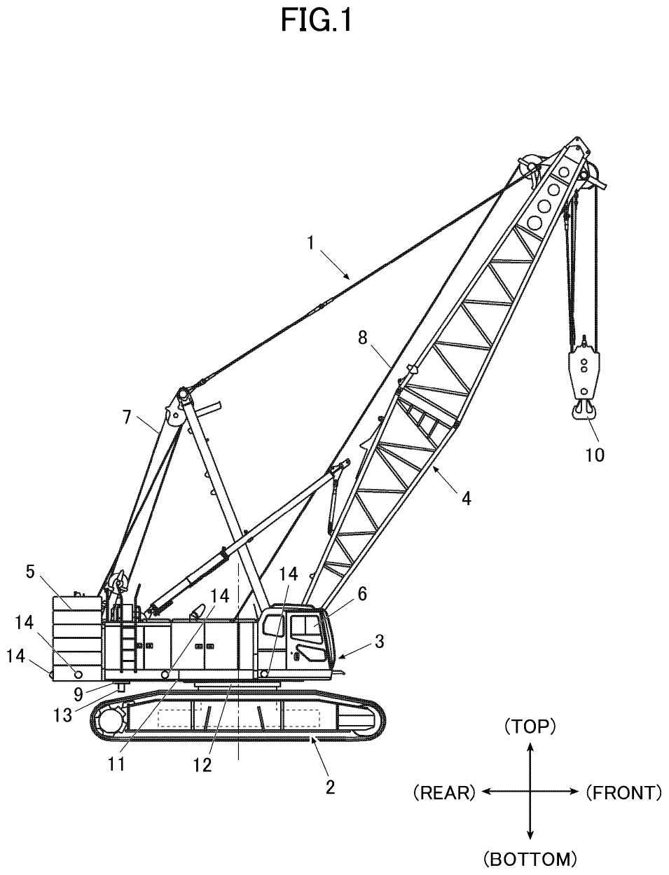

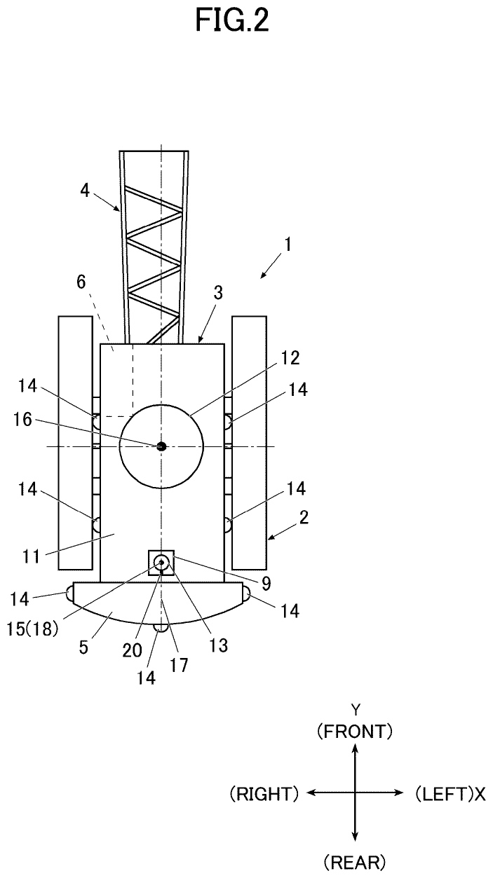

FIG. 1 is a side view of a crane 1 as a working machine. FIG. 2 is a bottom view of the crane 1 shown in FIG. 1.

As shown in FIG. 1, the crane 1 is what is called a mobile crawler crane. Specifically, the crane 1 is equipped with a crawler type lower traveling body 2 capable of self-propelling and an upper swivel body 3 mounted on the lower traveling body 2 capable of swiveling.

In the following, front-rear and right-left directions seen from an occupant of the crane 1 will be referred to as front-rear and right-left directions of the crane 1. Unless otherwise specified, the longitudinal direction of the crane 1 is described on the assumption that the lower traveling body 2 is aligned with the upper swivel body 3 in the front-rear direction (reference attitude). A top-bottom direction when the crane 1 is placed on a horizontal plane may be referred to as the vertical direction.

A boom 4 is mounted on a front part of the upper swivel body 3 capable of lifting. A counterweight 5 for balancing weights of the boom 4 and a suspended load is mounted on a rear part of the upper swivel body 3. A cabin 6 in which an operator sits and operates the crane 1 is arranged in a right front part of the upper swivel body 3.

The lifting or lowering operation of the boom 4 is performed by winding or unwinding a wire rope (lifting rope) 7 by a lifting winch (not shown). One end of a hoisting rope 8 is connected to a hook 10 at a top end of the boom 4, and the hook 10 is suspended from the top end of the boom 4. The other end of the hoisting rope 8 is wound around a hoisting winch (not shown) on the upper swivel body 3, and the hook 10 is raised and lowered by drive of the hoisting winch.

As shown in FIGS. 1 and 2, a main frame 11 disposed below the upper swivel body 3 is provided with a first measurement device mounting part 9 at a location avoiding a swivel bearing 12. A reference sensor 13 as a first measurement device to measure three-dimensional information of an object (e.g., a 360-degree LiDAR capable of measuring a range of 360°) is fixed (e.g. fastened with screws) to the first measurement device mounting part 9. The reference sensor 13 can measure 360° around a sensor central axis 15 extending vertically on the lower surface of the main frame 11. The reference sensor 13 irradiates light with a predetermined irradiation pattern at predetermined intervals while moving laser light from a space formed between the lower traveling body 2 and the upper swivel body 3 to an outer space of the crane 1, and measures position information (three-dimensional information including the position and shape (posture) of a surrounding object as well as position information of a single point of the surrounding object) of the surrounding object over a wide range. The sensor central axis 15 is a rotational axis parallel to an axis of a swivel center 16 of the upper swivel body 3. A plurality of the first measurement device mounting parts 9 may be provided. Here, the predetermined irradiation pattern refers to a method of moving the position to be irradiated with light and frequency of detecting the irradiated light. For example, as one pattern, the position to be irradiated with light is moved vertically to the upper end of the measurement range, and when the position is moved to the upper end of the measurement range, the position is moved horizontally by a predetermined distance, and the position is moved to the lower end of the measurement range repeatedly (irradiation is performed in a zigzag pattern in a vertical direction). As another pattern, the position is moved horizontally parallel to the right end of the measurement range, and when the position reaches the right end, the position is moved vertically by a predetermined distance, and the position is moved parallel to the left end of the measurement range repeatedly (irradiation is performed in a zigzag pattern in a horizontal direction). As another example, when the irradiation position is moved in the horizontal direction, the light may be irradiated while moving in parallel with the horizontal axis, and when moved in the vertical direction, the light may be irradiated while moving diagonally with respect to the vertical axis. In this manner, various irradiation patterns may be employed.

Further, as shown in FIGS. 1 and 2, a plurality of optional sensors 14 (e.g., LiDAR) as second position measurement devices are detachably installed on a lateral surface of the upper swivel body 3 and a lateral surface of the counterweight 5. The optional sensors 14 measure the position information (three-dimensional information including the position and shape (posture) of the surrounding object as well as the position information of a single point of the surrounding object) of objects around the crane 1 over a wide range. The optional sensors 14 irradiate an external space with laser light having a predetermined irradiation pattern different from the reference sensor 13, and measure the position information of the surrounding objects. The irradiation pattern of the reference sensor 13 and the optional sensor 14 may be the same. The optional sensor 14 is detachably arranged at any position of the upper swivel body 3 or the counterweight 5 of the crane 1 by a magnet, for example, and can be readily moved by hand without relying on tools. Thus, the operator can freely change an installation position even if a place where the operator wants to measure (the place where the operator wants to see) changes according to a situation of a site. A method for detachably attaching the optional sensor 14 to the upper swivel body 3 or the like is not limited to a magnet. For example, elastically deformable gripping members, such as spring members, may be accommodated in a plurality of preformed holes (attachment parts) provided in the counterweight 5 or the upper swivel body 3. An attachment shaft integral with the optional sensor 14 may be inserted into one of the holes (attachment parts) until a click is perceived, so that the attachment shaft is elastically held by the gripping member within the hole (attachment part). In this case, the attachment shaft of the optional sensor 14 can be pushed into the gripping member only by hand (without using tools), and the attachment shaft can be pulled out from the gripping member.

As shown in FIG. 2, the reference sensor 13 is disposed near the rear end of the main frame 11 of the upper swivel body 3 and on a center line 17 extending in the front-rear direction through the swivel center 16 of the upper swivel body 3. In FIG. 2, the reference attitude of the sensor 13 is defined as a state in which the sensor central axis (center of rotation) 15 is used as a reference position 18 of the reference sensor 13, and an attitude line 20 indicating the attitude of the reference sensor 13 is positioned along the center line 17 extending in the front-rear direction through the swivel center 16 of the upper swivel body 3. The position of the reference sensor 13 is a predetermined position and is recorded in a storage part 23. The reference sensor 13 is not limited to the position shown in FIG. 2, and can be fixed at any position as long as a fixing position is a predetermined position and recorded in the storage part 23.

### Configuration of Perimeter Monitoring System of Working Machine

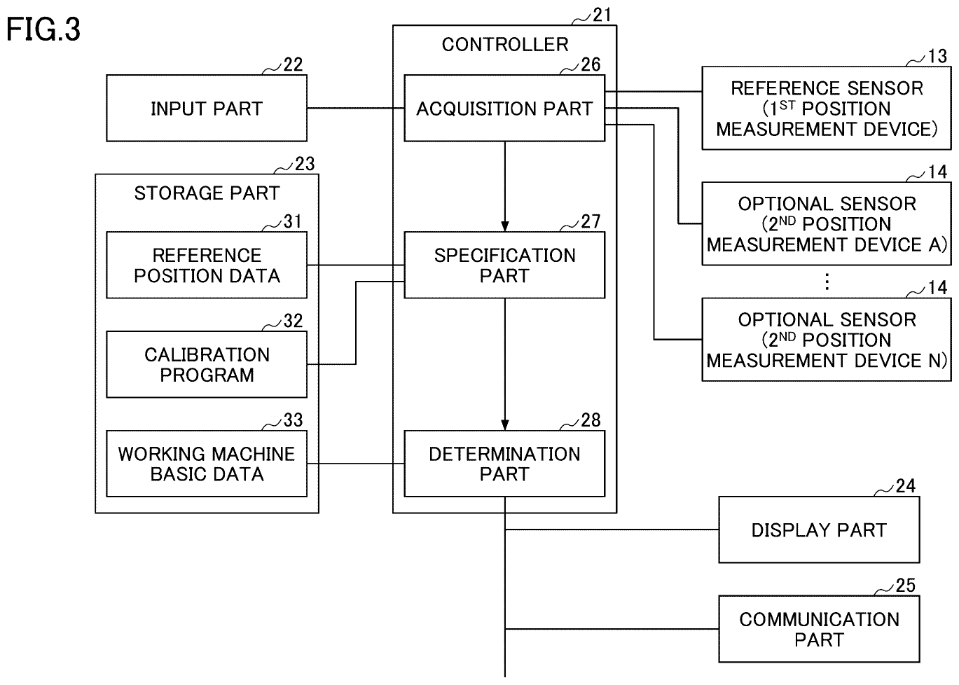

FIG. 3 is a block diagram illustrating the perimeter monitoring system of the crane 1 as a working machine. As shown in FIG. 3, in addition to the configuration of the crane 1, the perimeter monitoring system of the crane includes a controller 21, an input part 22, the reference sensor 13 (first position measurement device), the plurality of optional sensors 14 (second position measurement devices A-N), the storage part 23, a display part 24, and a communication part 25.

The controller 21 includes, for example, a central processing unit (CPU) and controls operation of each part of the crane 1. The controller 21 includes a function of an electronic control unit (ECU) and is arranged in the upper swivel body 3. Specifically, the controller 21 operates the crane 1 based on the operator's operation input from the input part 22, develops various programs stored in advance in the storage part 23, reads various data, and executes various processes using the developed programs and the various data read. The controller 21 has functions of an acquisition part 26, a specification part 27, and a determination part 28.

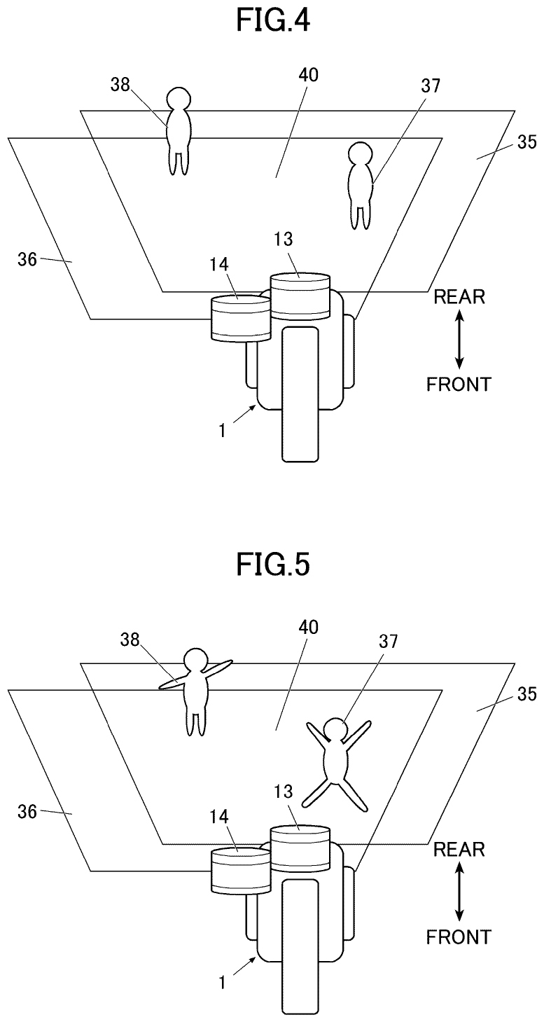

Based on measurement results from the reference sensor 13 and a plurality of optional sensors 14, the acquisition part 26 acquires the position information of objects 37 and 38 (people as measurement targets) in the measurement ranges 35 and 36 of the respective sensors (13, 14) (see FIG. 4). If the measurement range 35 of the reference sensor 13 is the reference measurement range of the crane 1, the measurement range 36 of the respective optional sensors 14 does not match the reference measurement range (35). Therefore, even if the reference sensor 13 and the optional sensors 14 measure the same objects 37 and 38, there is a deviation between the position information of the objects 37 and 38 in the reference measurement range (35) and the position information of the objects 37 and 38 in the measurement range 36 of the optional sensors 14. Therefore, in order to appropriately control the crane 1, it is necessary to calibrate the deviation of the position information of the objects 37 and 38 in the measurement range 36 of the optional sensors 14 from the position information of the objects 37 and 38 in the reference measurement range (35).

The specification part 27 calibrates the position information (position and attitude) of the optional sensors 14 with reference to the reference sensor 13. That is, the specification part 27 calibrates the position information (position and attitude) of the optional sensors 14 with reference to the reference sensor 13 by a calibration program 32 read from the storage part 23 using reference position data 31 of the reference sensor 13, the measurement results (positional information of objects 37 and 38) of the reference sensor 13, and the measurement results (positional information of objects 37 and 38) of the optional sensor 14 stored in the storage part 23. For example, as shown in FIG. 4, the specification part 27 calibrates the deviation (position deviation and attitude deviation) of the optional sensors 14 with reference to the reference sensor 13 by superimposing the objects 37 and 38 in the measurement range 36 of the optional sensor 14 on the objects 37 and 38 in the measurement range 35 of the reference sensor 13.

The determination part 28 compares the position information of an external object (objects other than calibration objects 37 and 38 shown in FIG. 4) calibrated by the specification part 27 with working machine basic data 33 (off-limits area data) previously recorded in the storage part 23, and determines whether the external object can be an obstacle.

The input part 22 includes various operation buttons, a keyboard, and the like, operated by the operator, and can input signals related to the operation of the crane 1 to the controller 21. When a display surface is a touch panel, the input part 22 includes an input button displayed on the touch panel. When the controller 21 is operated from an external information terminal, the input part 22 includes the external information terminal.

As the reference sensor 13 (first position measurement device), a 360-degree LiDAR capable of measuring 360° around the reference position 18 is used. The reference sensor 13 can measure three-dimensional information (position and posture (shape)) of the objects 37 and 38 and three-dimensional information (position and posture (shape)) of objects (objects other than the calibration objects 37 and 38 shown in FIG. 4) outside the crane 1. Note that, any sensor, for example a millimeter-wave, stereo camera, or ultrasonic sensor, may be used instead of the 360-degree LiDAR, as long as it can measure three-dimensional information of the objects 37 and 38. However, if a LiDAR sensor is used, the shape can be measured with high accuracy. In order to perform 360-degree measurement around the working machine, there is no limitation to a sensor that performs sensing while rotating about a central axis like a LiDAR; a sensor that is capable of simultaneously measuring entire surroundings may also be used.

The optional sensor 14 (second position measurement device) uses a LIDAR similar to the reference sensor 13 or a LIDAR different from the reference sensor 13, and can measure three-dimensional information (position and posture (shape)) of the objects 37 and 38 and three-dimensional information (position and posture (shape)) of the objects (objects other than the calibration objects 37 and 38 shown in FIG. 4) outside the crane 1. As the optional sensor 14, any sensor may be used instead of the LiDAR, as long as it includes a distance measuring function and an image detecting function, and is capable of measuring three-dimensional information of the objects 37 and 38.

The storage part 23 is a memory including, for example, RAM (Random Access Memory) and ROM (Read Only Memory), and stores various programs and data, and also functions as a working area of the controller 21. The storage part 23 of the present embodiment stores the reference position data 31, the calibration program 32, the working machine basic data 33, and the like.

The reference position data 31 includes three-dimensional information (reference position 18 and reference attitude information) of the reference sensor 13 in the reference measurement range 35.

The calibration program 32 calibrates the position information (position and attitude) of the optional sensor 14 with reference to the reference sensor 13. The calibration program 32 includes a program for calibrating between sensors (13, 14) based on a positioning method such as ICP or RANSAC capable of processing a measurement point group of each sensor (13, 14).

The working machine basic data 33 includes a right-left width of the lower traveling body 2 of the crane 1, a front-rear length of the lower traveling body 2 of the crane 1, a swivel radius of the upper swivel body 3, the off-limits area data, and the like.

The display part 24 is, for example, a liquid crystal display, organic electroluminescent display, or other display, and displays various information based on a display signal input from the controller 21. The display part 24 may be a touch panel serving as a part of the input part 22.

The communication part 25 is a communication device capable of transmitting and receiving various information with, for example, an external information terminal (not shown).

### First Example of Object Measurement by Reference Sensor and Optional Sensor

FIG. 4 is a drawing illustrating a first example of object measurement using a reference sensor 13 (first position measurement device) and an optional sensor 14 (second position measurement device).

As shown in FIG. 4, the reference sensor 13 and the optional sensor 14 are installed at different positions of the crane 1. As a result, the measurement range 35 (reference measurement range) of the reference sensor 13 and the measurement range 36 of the optional sensor 14 are respectively unique and different measurement ranges for each sensor (13, 14), but an overlapping measurement range 40 occurs in part. Therefore, objects 37 and 38 (two people such as standing workers) are placed in the overlapping measurement range 40, and the objects 37 and 38 are measured by the reference sensor 13 and the optional sensor 14, respectively.

However, even if the reference sensor 13 and the optional sensor 14 measure the same objects 37 and 38, positional information of the objects 37 and 38 in the reference measurement range 35 and positional information of the objects 37 and 38 in the measurement range 36 of the optional sensor 14 are deviated. Therefore, as described above, in order to properly control the crane 1, the positional information of the objects 37 and 38 in the measurement range 36 of the optional sensor 14 is calibrated against the positional information of the objects 37 and 38 in the reference measurement range 35.

Thus, according to the present embodiment, by using workers (people) as the objects 37 and 38, it is not necessary to separately prepare the objects for measurement, and a cost can be saved and efficiency can be improved.

### Second Example of Object Measurement With Reference Sensor and Optional Sensor

FIG. 5 is a drawing illustrating a second example of object measurement using the reference sensor 13 (first position measurement device) and optional sensor 14 (second position measurement device). In the second example shown in FIG. 5, the same reference numerals are assigned to the same parts as in the first example shown in FIG. 4, and duplicate descriptions are omitted.

As shown in FIG. 5, the second example shows a state in which two people as objects are in different poses. Thus, when two people are in different poses, difference in characteristics of each person becomes clear, and landmarks when the measurement range 35 and the measurement range 36 are superimposed become clear, which facilitates a process of calibrating the deviation of the positional information of objects 37 and 38 in the measurement range 36 from the positional information of objects 37 and 38 in the measurement range 35.

### Third Example of Object Measurement Using Reference Sensor and Optional Sensor

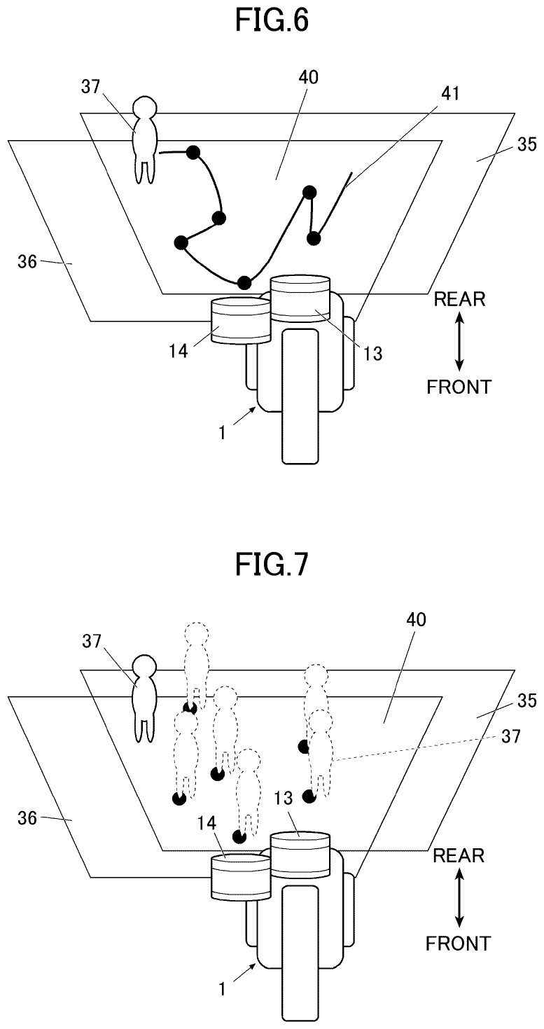

FIG. 6 is a drawing illustrating a third example of object measurement using the reference sensor 13 (first position measurement device) and the optional sensor 14 (second position measurement device). In the third example shown in FIG. 6, the same reference numerals are given to the same parts as in the first example shown in FIG. 4, and duplicate descriptions are omitted.

As shown in FIG. 6, in the third example, one person 37 as an object meanders through the overlapping measurement range 40, and the reference sensor 13 and the optional sensor 14 measure the person 37 at a plurality of points of a meandering walking course 41 of the person 37. According to this third example, when the person 37 changes walking direction, characteristics tend to appear, and landmarks when the measurement range 35 and the measurement range 36 are superimposed are clarified, which facilitates a process of calibrating the deviation of the position information of the object 37 in the measurement range 36 from the position information of the object 37 in the measurement range 35.

### Fourth Example of Object Measurement by Reference Sensor and Optional Sensor

FIG. 7 is a drawing illustrating a fourth example of object measurement using the reference sensor 13 (the first position measurement device) and the optional sensor 14 (the second position measurement device). In the fourth example shown in FIG. 7, the same reference numerals are given to the same parts as in the first example shown in FIG. 4, and duplicate descriptions are omitted.

As shown in FIG. 7, in the fourth example, one person 37 as an object moves to a plurality of points in the overlapping measurement range 40, and one person 37 is measured by the reference sensor 13 and the optional sensor 14 at each point. According to the fourth example, since the person 37 is stopped at each point, the measurement results of the reference sensor 13 and the optional sensor 14 can be acquired with greater stability than in the third example.

### Flow Chart of Obstacle Detection in Embodiment One

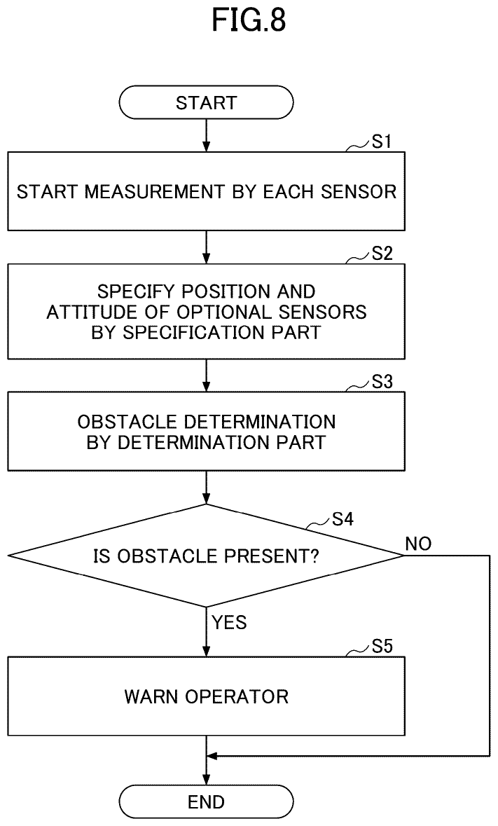

FIG. 8 is a flowchart of obstacle detection using the perimeter monitoring system for the working machine according to the present embodiment.

In FIG. 8, obstacle detection using the sensors (reference sensor 13, optional sensor 14) of the crane 1 starts when the operator confirms that the people 37 and 38 as measurement targets are placed in the measurement range, and the operator inputs a start signal from the input part 22. The controller 21 operates the sensors (13, 14) based on the start signal from the input part 22. Each sensor (13, 14) measures the people 37 and 38 as the calibration objects and the objects other than the people 37 and 38 as the calibration objects outside the crane 1 (step S1).

Next, the controller 21 calibrates the position information (position and attitude) of the optional sensor 14 with reference to the reference sensor 13 by the specification part 27. That is, the specification part 27 of the controller 21 uses the reference position data 31 of the reference sensor 13, the measurement results of the reference sensor 13 (positional information of objects 37 and 38), and the measurement results of the optional sensor 14 (positional information of objects 37 and 38) stored in the storage part 23, and calibrates the position information (position and attitude) of the optional sensor 14 with reference to the reference sensor 13 by the calibration program 32 read from the storage part 23 (step S2).

Next, the controller 21 compares the position information of the external object (objects other than the calibration objects 37 and 38 shown in FIG. 4) calibrated by the specification part 27 with the working machine basic data 33 (off-limits area data) previously stored in the storage part 23, and determines whether or not the external object can be an obstacle by the determination part 28 (step S3).

Next, when the determination part 28 determines that there is an obstacle (step S4), the controller 21 displays existence of the obstacle and position data of the obstacle on the display part 24, warns the operator (step S5), and ends the obstacle measurement work. When the determination part 28 determines that there is no obstacle (step S4), the controller 21 ends the obstacle measurement work.

### Effect of Embodiment One

The perimeter monitoring system of the crane (working machine) 1 according to the present embodiment can correct the deviation (position and attitude) of the optional sensor 14 based on the reference sensor 13. Therefore, the optional sensor 14 can be set relatively freely according to the configuration and work contents of the crane (working machine) 1, and a degree of freedom of a monitoring application range as the perimeter monitoring is improved.

Moreover, in the perimeter monitoring system of the crane (working machine) 1 according to the present embodiment, by placing an object in the overlapping measurement range 40 between the measurement range 35 of the reference sensor 13 and the measurement range 36 of the optional sensor 14, the object in the overlapping measurement range 40 can correct the position and attitude of the optional sensor 14 relative to the reference sensor 13.

Moreover, in the perimeter monitoring system of the crane (working machine) 1 according to the present embodiment, when the people 37 and 38 as the objects are placed in the overlapping measurement range 40 between the measurement range 35 of the reference sensor 13 and the measurement range 36 of the optional sensor 14, the people 37 and 38 at the work site (e.g., workers) can be used, and the people 37 and 38 take different poses, which enable to form features in complicated shapes, and it is not necessary to prepare a special object for measurement, so that the deviation (deviation of position and attitude) of the optional sensor 14 relative to the reference sensor 13 can be corrected readily and inexpensively.

### Embodiment Two

Hereinafter, Embodiment two of the perimeter monitoring system for the working machine according to the second mode of the present disclosure will be described in detail with reference to the drawings. In descriptions of the present embodiment, descriptions same as those of the perimeter monitoring system for the working machine according to Embodiment one are omitted, and differing configurations are described in detail.

### Example of Object Measurement by Reference Sensor and Optional Sensor of Embodiment Two

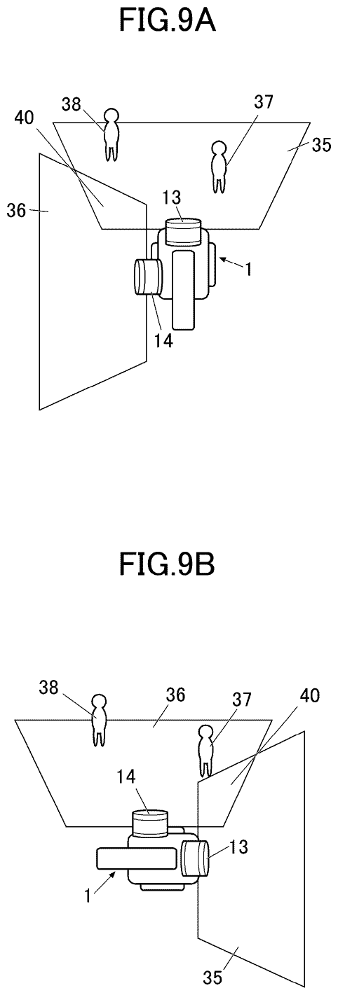

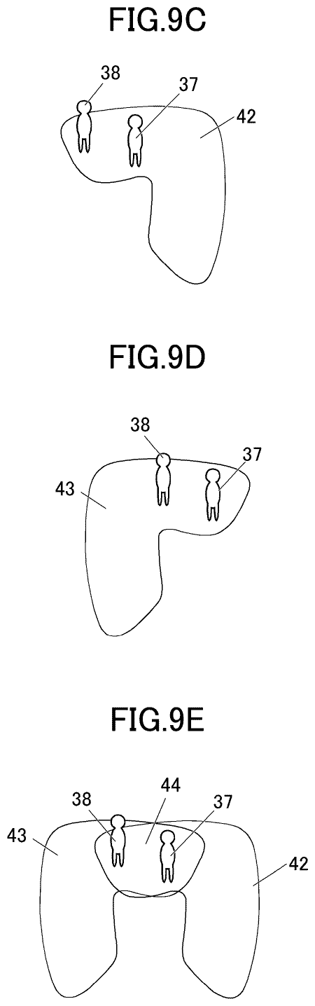

FIGS. 9A to 9E are drawings illustrating an example of the object measurement using the reference sensor 13 (first position measurement device) and the optional sensor 14 (second position measurement device).

As shown in FIG. 9A, the reference sensor 13 and the optional sensor 14 are installed at different positions of the crane 1. Then, the measurement range 35 (reference measurement range) of the reference sensor 13 and the measurement range 36 of the optional sensor 14 are different measurement ranges 35 and 36 for each sensor (13, 14), and the measurement range 35 of the reference sensor 13 and the measurement range 36 of the optional sensor 14 do not have enough overlapping measurement ranges 40 to place the common objects (people such as workers) 37 and 38. Then, as shown in FIG. 9B, the measurement is continued by the reference sensor 13 and the optional sensor 14 while the upper swivel body 3 of the crane 1 swivels 90° with respect to the lower traveling body 2. As a result, as shown in FIG. 9C, the measurement range 42 of the reference sensor 13 after swiveling is shaped like the measurement range 36 of the optional sensor 14 shown in FIG. 9B and the measurement range 35 of the reference sensor 13 being smoothly connected, and the first three-dimensional information (position and posture information) of the two people 37 and 38 is measured by the reference sensor 13. Also, as shown in FIG. 9D, the measurement range 43 of the optional sensor 14 before swiveling is shaped like the measurement range 36 of the optional sensor 14 shown in FIG. 9A and the measurement range 35 of the reference sensor 13 being smoothly connected, and the second three-dimensional information (position and posture information) of the two people 37 and 38 is measured by the optional sensor 14.

FIG. 9E is a drawing showing a combination of the measurement range 42 after swiveling shown in FIG. 9C and the measurement range 43 after swiveling shown in FIG. 9D, in which the two people 37 and 38 measured in both ranges 42 and 43 are positionally aligned. In FIG. 9E, an overlapping measurement range 44 of the measurement ranges 42 and 43 after swiveling occurs, and two people 37 and 38, which are landmarks, are measured in the overlapping measurement range 44.

### Effect of Embodiment Two

The present embodiment has the following effects in addition to the effects described in Embodiment one.

According to the method of measuring the objects (two people 37, 38) by the reference sensor 13 and the optional sensor 14 of the present embodiment, even if the measurement range 35 of the reference sensor 13 and the measurement range 36 of the optional sensor 14 do not generate a sufficient overlapping measurement range 40, or the measurement range 35 of the reference sensor 13 and the measurement range 36 of the optional sensor 14 do not generate any overlapping measurement range 40, the position and attitude of the optional sensor 14 with respect to the reference sensor 13 can be calibrated based on the first three-dimensional information and the second three-dimensional information.

Furthermore, by repeatedly swiveling the upper swivel body 3, the point group of the reference sensor 13 and the point group of the optional sensor 14 can be changed from a sparse point group to a dense point group. Therefore, since the object (people as landmarks 37, 38) in the point group pattern measured by the respective sensors can be clarified, the position and attitude of the optional sensor 14 can be calibrated based on the reference sensor 13.

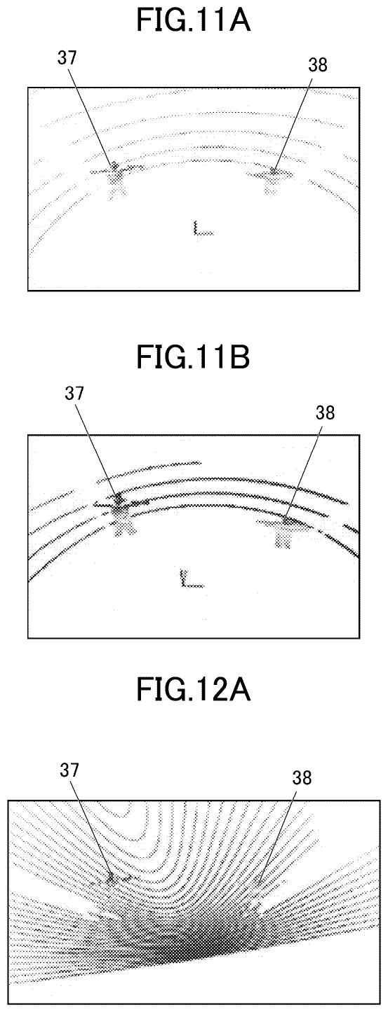

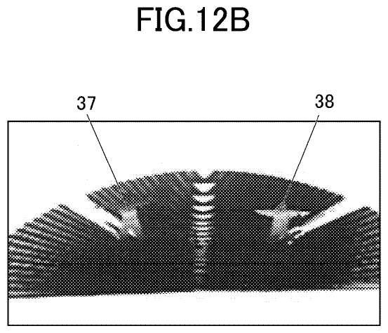

As shown in FIGS. 11A, 11B, 12A, and 12B, in the perimeter monitoring system for the working machine according to Embodiment two of the present disclosure, the irradiation patterns of the reference sensor 13 and the optional sensor 14 are different. Therefore, it is possible to adopt a sensor with an appropriate irradiation pattern at the installation position of the reference sensor 13 and a sensor with an appropriate irradiation pattern at the optional sensor 14 installed at another installation position. Conversely, since the irradiation patterns of the information measured by the respective sensors are different, it is difficult for the point groups to correspond one-to-one. However, although the irradiation patterns are different, the point groups of the reference sensor 13 and the optional sensor 14 can be changed from sparse point groups to dense point groups by repeatedly swiveling the upper swivel body 3 and measuring three-dimensional information with the respective sensors. Therefore, since the object (people as landmarks 37, 38) in the point group pattern measured by the respective sensors can be clarified, the position and attitude of the optional sensor 14 can be calibrated with the reference sensor 13 as a reference.

The perimeter monitoring system for the working machine according to Embodiment two of the present disclosure exemplifies the case where the irradiation patterns of the reference sensor 13 and the optional sensor 14 are different, but it is not limited to this, and the reference sensor 13 and the optional sensor 14 having the same irradiation pattern may be used.

### Modification

As shown in FIG. 9E, in the present embodiment, the position and attitude of the optional sensor 14 with respect to the reference sensor 13 are calibrated based on the three-dimensional information of the object (people 37, 38) in the measurement range 42 after swiveling of the reference sensor 13 and the three-dimensional information of the object (people 37, 38) in the measurement range 43 after swiveling of the optional sensor 14, but the method of measuring the objects is not limited to the aforementioned. That is, it is sufficient that at least one of the reference sensor 13 and the optional sensor 14 can generate three-dimensional information for use in the specification part 27 based on three-dimensional information acquired at two swivel angles (e.g., 0° and 90° of the optional sensor 14 shown in FIG. 9A, or 0° and 90° counterclockwise of the reference sensor 13 shown in FIG. 9B).

### Effect of Modification

The same effect as Embodiment two can be acquired by such a modification.

In addition, in this modification, at least one of the reference sensor 13 and the optional sensor 14 can generate three-dimensional information for use in the specification part 27 based on three-dimensional information acquired at two swivel angles. Therefore, compared with the case where the reference sensor 13 and the optional sensor 14 continuously measure three-dimensional information during the swivel of the upper swivel body 3, an amount of three-dimensional information data can be reduced, and the calibration process by the specification part 27 becomes more efficient.

### Flow Chart of Obstacle Detection in Embodiment Two

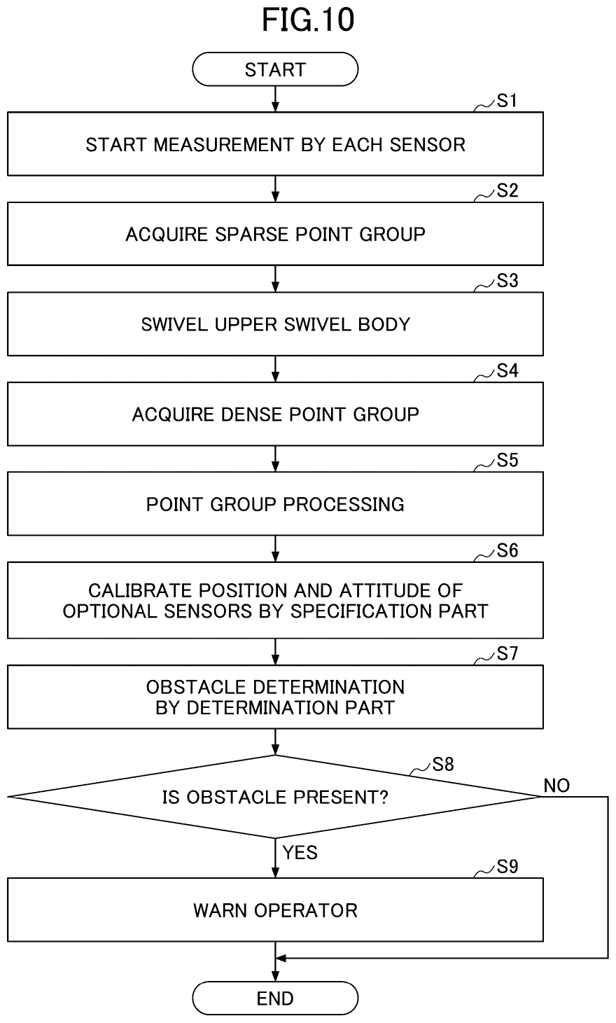

FIG. 10 is a flowchart of obstacle detection in the present embodiment.

In FIG. 10, obstacle detection using each sensor (reference sensor 13, optional sensor 14) of the crane 1 starts when the operator confirms that people 37 and 38 as measurement targets are placed in the measurement range 35, and the operator inputs a start signal from the input part 22. The controller 21 operates each sensor (13, 14) based on the start signal from the input part 22. Each sensor (13, 14) measures the people 37 and 38 as the calibration objects and the objects other than the people 37 and 38 as the calibration objects outside the crane 1 (step S1).

The measurement result of each sensor (13, 14) is acquired as a sparse point group by the acquisition part 26 (step S2). FIG. 11A is a drawing illustrating a point group that is a measurement result (sparse point group) of the reference sensor (360-degree LiDAR) 13. FIG. 12A is a drawing illustrating a point group as a measurement result (sparse point group) of the optional sensor 14. As shown in FIGS. 11A and 12A, according to the measurement result consisting of the sparse point group, it is difficult to clearly distinguish people 37 and 38 from the point group.

Next, the controller 21 repeatedly swivels the upper swivel body 3 and causes the sensors 13 and 14 to measure the people 37 and 38 as the calibration objects and the objects other than the people 37 and 38 as the calibration objects outside the crane 1 (step S3).

The measurement results of the sensors 13 and 14 in step S3 are acquired as a dense point group by the acquisition part 26 (step S4). FIG. 11B is a drawing illustrating a point group that is a measurement result (dense point group) of the reference sensor (360-degree LiDAR) 13. FIG. 12B is a drawing illustrating a point group as a measurement result (dense point group) of the optional sensor 14. As shown in FIGS. 11B and 12B, according to the measurement results consisting of dense point groups, people 37 and 38 can be clearly distinguished from the point groups. Incidentally, by repeatedly swiveling the upper swivel body 3 while continuing the measurement of the reference sensor 13 and the optional sensor 14, the point groups which are the measurement results of the reference sensor 13 and the optional sensor 14 are superimposed with slight deviation, and are acquired as dense point groups by the acquisition part 26.

Next, the controller 21 executes the point group processing to make the measurement point groups of each sensor (13, 14) easier to handle by ICP, RANSAC and the like included in the calibration program 32 recorded in the storage part 23 (step S5).

Next, the controller 21 calibrates the position information (position and attitude) of the optional sensor 14 with reference to the reference sensor 13 by the specification part 27. That is, the specification part 27 of the controller 21 uses the reference position data 31 of the reference sensor 13 stored in the storage part 23, the measurement result of the reference sensor 13 (positional information of objects 37 and 38), and the measurement result of the optional sensor 14 (positional information of objects 37 and 38), and calibrates the position information (position and attitude) of the optional sensor 14 with reference to the reference sensor 13 by the calibration program 32 read from the storage part 23 (step S6).

Next, the controller 21 compares the position information of the external object (objects other than the calibration objects 37 and 38 shown in FIGS. 9A to 9E) calibrated by the specification part 27 with the working machine basic data 33 (off-limits area data) previously stored in the storage part 23, and determines whether or not the external object can be an obstacle by the determination part 28 (step S7).

Next, when the determination part 28 determines that there is an obstacle (step S8), the controller 21 displays existence of the obstacle and position data of the obstacle on the display part 24, warns the operator (step S9), and ends the obstacle measurement work. When the determination part 28 determines that there is no obstacle (step S8), the controller 21 ends the obstacle measurement work.

### Embodiment Three

Embodiment three of the perimeter monitoring system for the working machine according to the first mode of the present disclosure will be described below in detail with reference to the drawings. In the above-described Embodiments one and two according to the second mode of the present disclosure, a case in which a plurality of object detection devices for detecting objects around the working machine are a first position measurement device and a second position measurement device for measuring three-dimensional information of objects has been described.

With respect to the above, in the present embodiment, the object detection device is not limited to a position measurement device for measuring three-dimensional information of an object. Specifically, in the perimeter monitoring system for the working machine of the present embodiment, the reference sensor 13 and the optional sensor 14 shown in FIG. 3 may include a device for detecting an object using an image, such as a camera.

The perimeter monitoring system for the working machine of the present embodiment and the perimeter monitoring system for the working machine of each of the aforementioned embodiments have the following points in common. That is, the perimeter monitoring system for the working machine includes a plurality of object detection devices for detecting an object around the working machine. The perimeter monitoring system for the working machine also includes a controller for calibrating at least one other object detection device detachably attached to the working machine based on at least one object detection device fixed to the working machine.

Further, in the perimeter monitoring system for the working machine of the present embodiment, the controller 21 may have functions such as an extraction part and a calibration part described later in addition to the functions such as the acquisition part 26, the specification part 27, and the determination part 28 shown in FIG. 3. These functions are also realized when the controller 21 executes various programs stored in the storage part 23 or the like by the CPU. The extraction part and the calibration part may be included in the specification part 27.

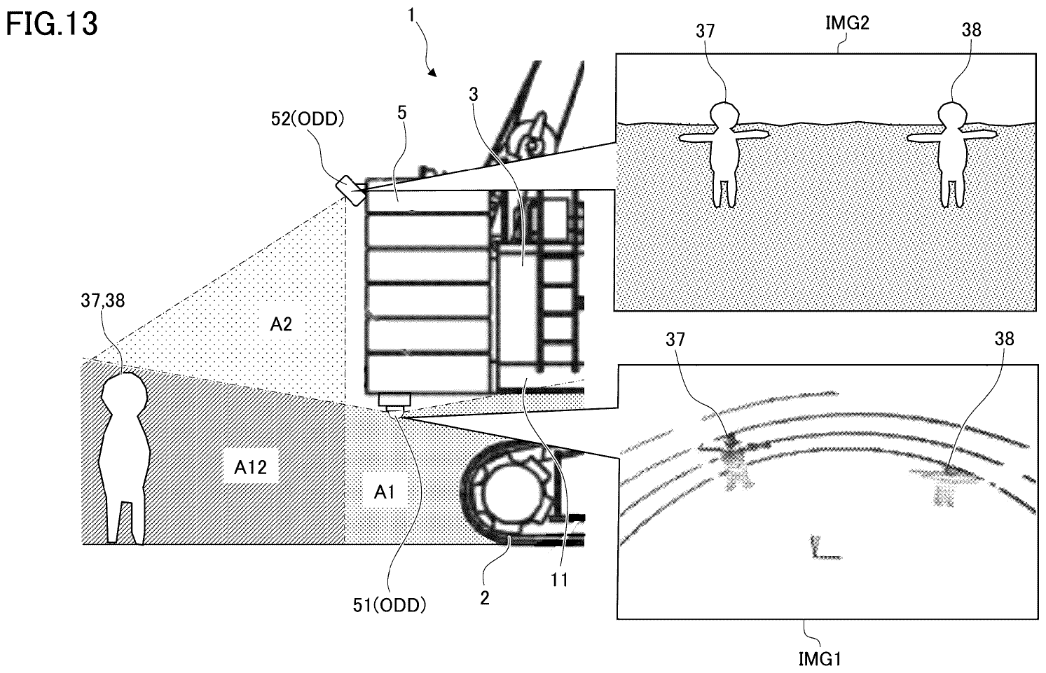

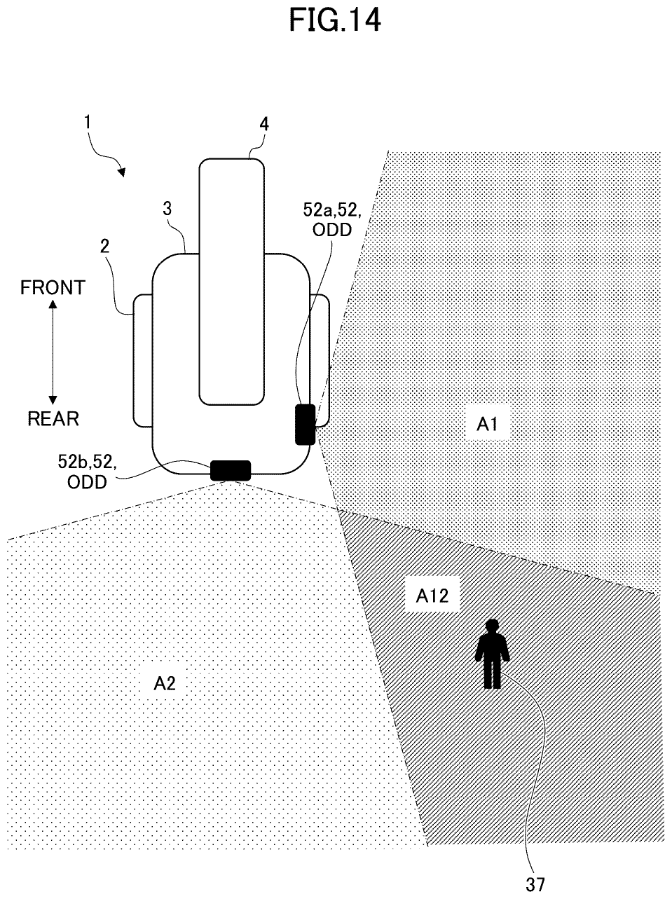

FIGS. 13, 14, and 15A to 15C are drawings illustrating examples of a plurality of object detection devices ODDs in the perimeter monitoring system for the working machine according to the present embodiment. More specifically, FIG. 13 shows an enlarged view of the right rear part of the crane 1 shown in FIG. 1 and a result of object detection by the plurality of object detection devices ODDs. In the example shown in FIG. 13, the plurality of object detection devices ODDs include at least one LiDAR 51 and at least one camera 52.

For example, the LiDAR 51 is detachably attached to the lower surface of the main frame 11 of the crane 1 or the lower surface of the counterweight 5, similar to the optional sensor 14 of Embodiment one. For example, the camera 52 is fixed to the upper part of the rear end of the upper swivel body 3 or the counterweight 5 in the center in a width direction via an attachment such as a bracket, similar to the reference sensor 13 of Embodiment one.

Here, a state in which the object detection device ODD is detachably attached to the crane 1 includes, for example, a state in which an operator can attach and remove the object detection device ODD without using a tool. A state in which the object detection device ODD is fixed to the crane 1 includes a state in which the object detection device ODD cannot be attached and removed, and the position and attitude of the object detection device ODD cannot be adjusted unless the operator uses a tool. Attachment positions of the LiDAR 51 and the camera 52 to the crane 1 shown in FIG. 13 are examples and are not particularly limited.

The LiDAR 51, for example, can detect an object in a detection range A1 having an entire periphery of 360° centered on the center line of the LiDAR 51 parallel to the top-bottom direction of the crane 1, as shown by alternate long and two short dashes lines and the dense dot hatch in FIG. 13. The camera 52, for example, can detect an object in a radial detection range A2 including an area below and obliquely below the camera 52, as shown by alternate long and short dash lines and the sparse dot hatch in FIG. 13. Also, in the example shown in FIG. 13, as shown by hatched lines, there is an overlapping detection range A12 in which the detection range A1 of the LiDAR 51 and the detection range A2 of the camera 52 overlap.

Therefore, when the objects 37 and 38 such as a person are placed in the overlapping detection range A12 shown in FIG. 13, the same objects 37 and 38 are detected by a plurality of different object detection devices ODDs including the LiDAR 51 and the camera 52. Specifically, as shown in the lower right image IMG1 of FIG. 13, point group information of the objects 37 and 38 and the surrounding objects (e.g., ground surface, etc.) is acquired by the LiDAR 51. Also, as shown in the upper right image IMG2 of FIG. 13, images of the objects 37 and 38 and the surrounding objects are acquired by the camera 52.

When the camera 52 is a monocular camera, two-dimensional image information, which is two-dimensional information of an object, is acquired by the camera 52. When the camera 52 is a stereo camera, three-dimensional information of an object can be acquired by acquiring distance information to the object based on parallax information of the stereo camera in addition to two-dimensional image information of the object by the camera 52.

FIG. 14 is a schematic bird's eye view of the crane 1 shown in FIG. 1 seen from above. In the example shown in FIG. 14, the plurality of object detection devices ODDs include, for example, at least two cameras 52. A first camera 52a is detachably mounted on the right rear part of the upper swivel body 3 or the right part of the counterweight 5 of the crane 1, for example, as in the case of the optional sensor 14 of Embodiment one. A second camera 52b is fixed to the rear end of the upper swivel body 3 or the counterweight 5 through a mounting part such as a bracket, for example, as in the case of the reference sensor 13 of Embodiment one. Mounting positions of these cameras 52 to the crane 1 are examples, and are not particularly limited.

The first camera 52a, for example, can detect an object in the detection range A1 having a lateral viewing angle of about 150° centered on a centerline parallel to the width direction of the crane 1, as shown by alternate long and two short dashes lines and a dense dot hatch in FIG. 14. The second camera 52b, for example, can detect an object in the detection range A2 having a lateral viewing angle of about 150° centered on a centerline parallel to the front-rear direction of the crane 1, as shown by alternate long and short dash lines and a sparse dot hatch in FIG. 14. In the example shown in FIG. 14, there is an overlapping detection range A12 in which the detection range A1 of the first camera 52a and the detection range A2 of the second camera 52b overlap, as shown by hatched lines.

Therefore, when an object 37 such as a person is placed in the overlapping detection range A12 shown by a hatched line in FIG. 14, the same object 37 is detected by a plurality of different object detection devices ODDs including the first camera 52a and the second camera 52b. Specifically, the object 37 and the surrounding object are photographed from different angles by the first camera 52a and the second camera 52b, respectively, and a plurality of different images including the object 37 are acquired.

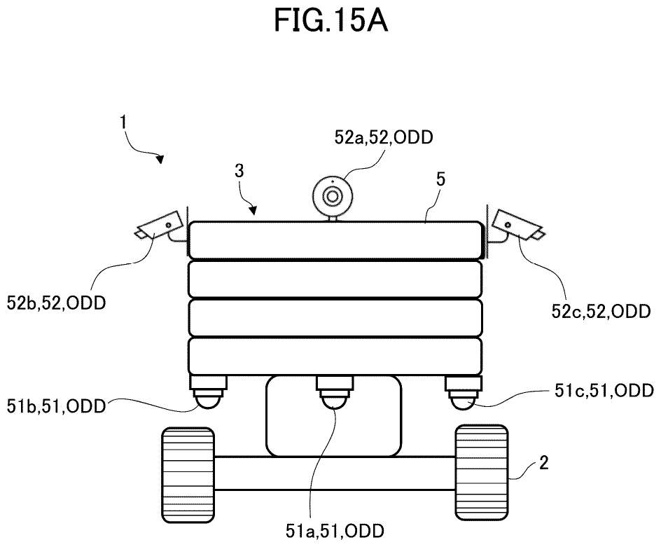

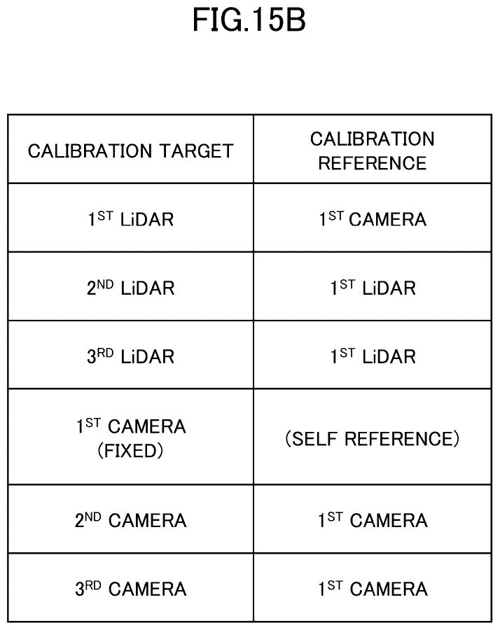

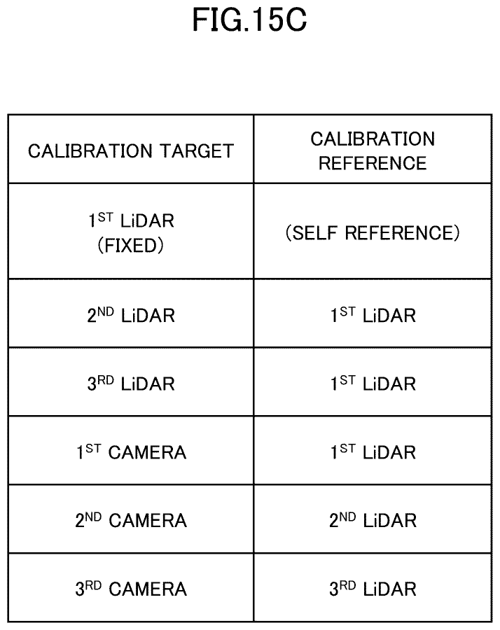

FIG. 15A is a schematic rear view of the crane 1 shown in FIG. 1 seen from the rear. In the example shown in FIG. 15A, the plurality of object detection devices ODDs include, for example, a first object detection device ODD fixed to the crane 1 as a working machine, and second and third object detection devices ODDs detachably attached to the crane 1 as a working machine. More specifically, in the example shown in FIG. 15A, the plurality of object detection devices ODDs include, for example, at least three LiDARs 51 and at least three cameras 52.

FIG. 15B and FIG. 15C are tables illustrating examples of combinations of the object detection device ODD to be calibrated and the object detection device ODD as the reference. That is, in the example shown in the table in FIG. 15B, the first object detection device ODD fixed to the crane 1 is, for example, the first camera 52a shown in FIG. 15A. In this case, the first camera 52a stores information on its own installation conditions and specifications, such as coordinates of the mounting position of the first camera 52a, attitude, viewing angle, imaging range, and the like, in advance in a non-volatile storage device, and the information on its own installation conditions, and the like, and specifications, and the like, is a calibration reference.

In the example shown in the table in FIG. 15B, with respect to devices other than the first camera 52a as the first object detection device ODD fixed to the crane 1 as a working machine, the second and third object detection devices ODDs are detachably attached to the crane 1. In this case, the second object detection devices ODDs can be calibrated based on the first object detection device ODD, and the third object detection devices ODDs can be calibrated based on one of the calibrated second object detection devices ODDs.

Specifically, first, the first LiDAR 51a, second camera 52b, and third camera 52c, which serve as the second object detection devices ODDs to be calibrated, can be calibrated using the first camera 52a, which serves as the first object detection device ODD and a calibration reference. Subsequently, the second LiDAR 51b and third LiDAR 51c, which serve as the third object detection devices ODDs, can be calibrated using the first LiDAR 51a, which serves as one of the second object detection devices ODDs and has already been calibrated, as a calibration reference.

In the example shown in the table of FIG. 15C, with respect to devices other than the first LiDAR 51a as the first object detection device ODD fixed to the crane 1 as a working machine, the second and third object detection devices ODDs are detachably attached to the crane 1. In this case, the second object detection devices ODDs can be calibrated based on the first object detection device ODD, and the third object detection devices ODDs can be calibrated based on one of the calibrated second object detection devices ODDs.

Specifically, first, the second LiDAR 51b, third LiDAR 51c, and first camera 52a, which serve as the second object detection devices ODDs to be calibrated, can be calibrated using the first LiDAR 51a, which serves as the first object detection device ODD and a calibration reference. Subsequently, the second camera 52b, which serves as one of the third object detection devices ODDs, can be calibrated using the second LiDAR 51b, which serves as one of the second object detection devices ODDs and has already been calibrated, as a calibration reference. Similarly, the third camera 52c, which serves as one of the third object detection devices ODDs, can be calibrated using the third LiDAR 51c, which serves as one of the second object detection devices ODDs and has already been calibrated, as a calibration reference.

In the examples shown in the tables of FIGS. 15B and 15C, any plurality of object detection devices ODDs may be fixed to the crane 1. For example, in the example shown in the table of FIG. 15C, not only the first LiDAR 51a but also all LiDARs 51 including the second LiDAR 51b and the third LiDAR 51c may be fixed to the crane 1. In this case, all the LiDARs 51 can be treated as the first object detection devices ODDs fixed to the crane 1.

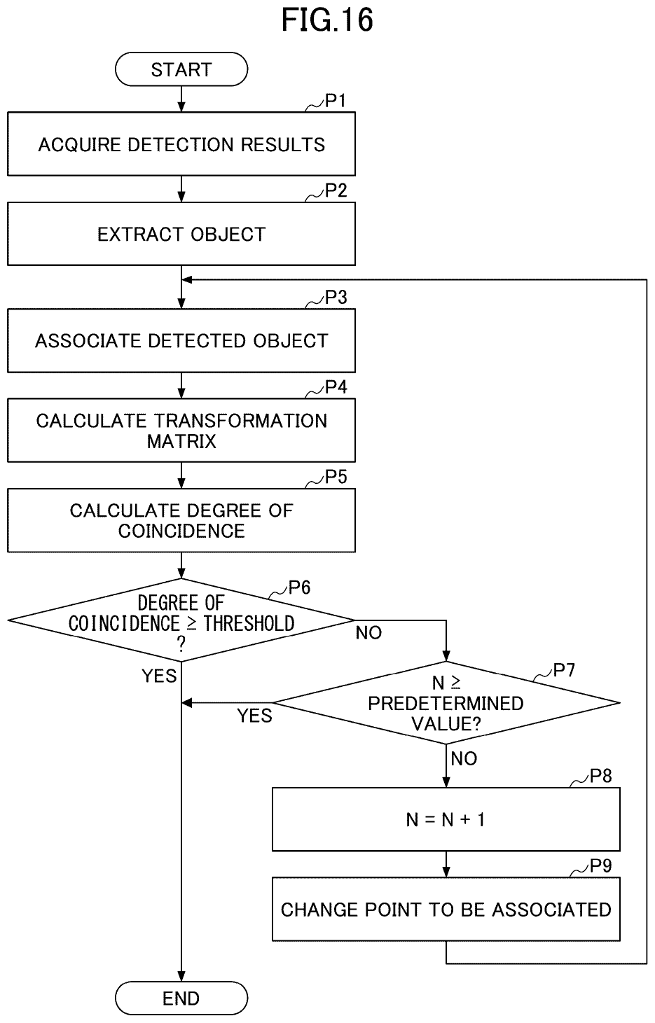

FIG. 16 is a flowchart of a calibration process by the controller 21 of the perimeter monitoring systems for the working machine according to the present embodiment.

Before starting a processing flow shown in FIG. 16, the operator performing calibration of the object detection device ODD places a calibration object at a position which can be detected by a plurality of object detection devices ODDs including the object detection device ODD of the calibration reference and the object detection device ODD to be calibrated. Specifically, as shown in FIGS. 13 and 14, for example, the calibration objects 37 and 38 are placed in the overlapping detection range A12 of the plurality of object detection devices ODDs. As the calibration objects 37 and 38, for example, a person can be placed as described above.

Then, the operator performing calibration of the object detection device ODD operates, for example, the input part 22 shown in FIG. 3, selects and inputs a calibration mode of the object detection device ODD from an operation menu displayed on the display part 24, and inputs a signal to start the calibration mode to the controller 21. When a signal to start the calibration mode is input from the input part 22, for example, the controller 21 starts the processing flow shown in FIG. 16.

When the controller 21 starts the processing flow shown in FIG. 16, for example, the acquisition part 26 acquires object detection results from a plurality of object detection devices ODDs (process P1). Among the plurality of object detection devices ODDs, for example, the acquisition part 26 acquires object detection results including detection results of the same object arranged in the overlapping detection range A12 from the object detection device ODD which is the calibration reference and the object detection device ODD which is a calibration target.

Specifically, as shown in FIG. 13, FIG. 15A, and FIG. 15B, for example, the acquisition part 26 acquires an object image from the calibration reference first camera 52a fixed to the crane 1 and also acquires point group information of the object from the calibration target first LiDAR 51a. Also, as shown in FIG. 13, FIG. 15A, and FIG. 15C, for example, the acquisition part 26 acquires point group information of the object from the calibration reference first LiDAR 51a fixed to the crane 1 and also acquires an object image from the calibration target first camera 52a.

Also, as shown in the table of FIG. 15B, for example, the acquisition part 26 acquires an object image from the calibration reference first camera 52a fixed to the crane 1 and also acquires object images from the calibration target second camera 52b and third camera 52c. Also, as shown in the table of FIG. 15C, for example, the acquisition part 26 acquires point group information of the object from the calibration reference first LiDAR 51a fixed to the crane 1 and also acquires object point group information from the calibration target second LiDAR 51b and third LiDAR 51c.

Here, for example, the acquisition part 26 may acquire detection results of an object including detection results of the same object placed in a plurality of different postures from the object detection device ODD serving as a calibration reference and the object detection device ODD serving as a calibration target among the plurality of object detection devices ODDs.

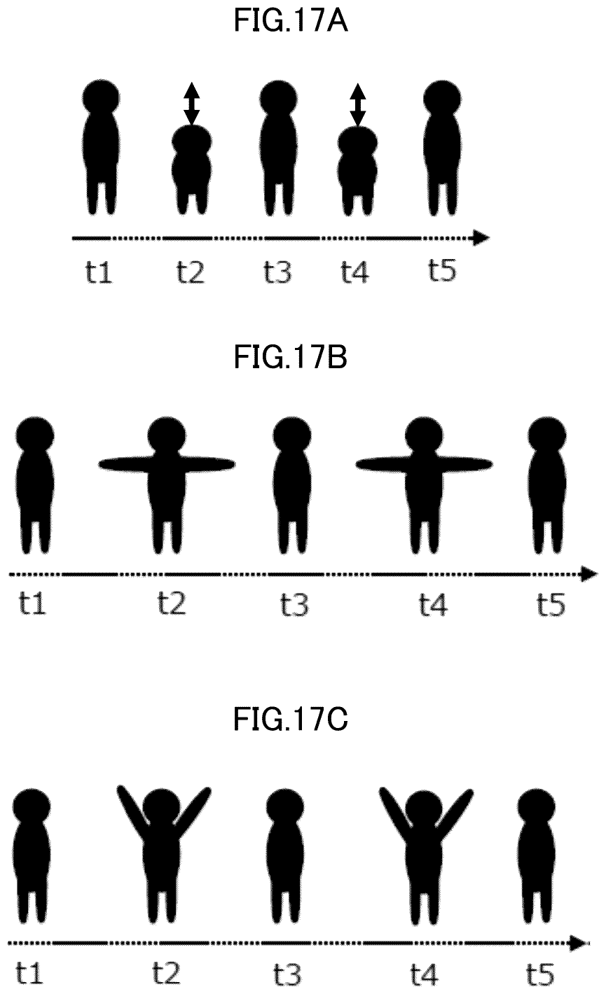

FIGS. 17A to 17C are schematic diagrams illustrating an example of a plurality of different postures of the same object detected by the object detection device ODD serving as a calibration reference and the object detection device ODD serving as a calibration target in the process P1 of FIG. 16. Posture changes of the object in FIGS. 17A and 17C include a plurality of postures in which the height of the same object is different. Posture changes of the object in FIG. 17B include a plurality of postures in which the width of the same object is different.

Specifically, the object in FIG. 17A undergoes posture changes from time t1 to time t5, including bending and stretching motions, alternating between an upright posture and a squatting posture. The same object is a person used for calibration.

The object in FIG. 17B undergoes posture changes from time t1 to time t5, including alternating between an upright posture with both arms lowered and an upright posture with both arms extended horizontally. The same object is a person used for calibration.

Moreover, the object in FIG. 17C undergoes posture changes from time t1 to time t5, including alternating between an upright posture with both arms lowered and an upright posture with both arms raised overhead. The same object is a person used for calibration.

The detection of the object performing motions shown in FIGS. 17A to 17C can be performed, for example, at a plurality of points within the overlapping detection range A12. In this case, a specific motion of the same object can be detected by a plurality of object detection devices ODDs at multiple points.

In the process P1 shown in FIG. 16, the controller 21 acquires the detection result of the object by the object detection devices ODDs by the acquisition part 26, for example. Then, the controller 21 extracts the detection result of the same object for calibration from the detection result of the object by the object detection devices ODDs (process P2).

In the process P2, the controller 21 extracts the detection result of the same object for calibration from the detection result of the object acquired from the object detection devices ODDs by the specification part 27 or the extraction part, for example. Specifically, the specification part 27 or the extraction part extracts the detection result of the object performing a specific operation shown in FIGS. 17A to 17C as the detection result of the same object for calibration from the detection result of the object by the object detection devices ODDs.

Further, the specification part 27 or the extraction part of the controller 21 extracts, for example, specific points such as a head, feet, and hands of a person as the same object as feature points based on specific actions such as bending and stretching by the extracted same object. Here, if the detection results of the object by the plurality of object detection devices ODDs include specific actions of the same object at a plurality of points, the specification part 27 or the extraction part may extract feature points of the same object at a plurality of points.

Next, the specification part 27 or the calibration part of the controller 21 associates the detection results of the same object, which are extracted from the detection results acquired by the plurality of object detection devices ODDs (process P3). Here, the specification part 27 or the calibration part associates, for example, contours or identical feature points of the same object extracted from the detection results of the object by the plurality of object detection devices ODDs with each other.

Next, the specification part 27 or the calibration part of the controller 21 calculates a transformation matrix based on, for example, contours or identical feature points of the same object extracted and associated from the detection results of the plurality of object detection devices ODDs (process P4).

Specifically, for example, suppose that the object detection device ODD used as the calibration reference and the object detection device ODD to be calibrated are the LiDAR 51 and the camera 52 shown in FIG. 13. In this case, the specification part 27 or the calibration part acquires coordinate conversion coefficients such that the contours or feature points of the objects 37 and 38 extracted from the point group information of the image IMG1 of the LiDAR 51 overlap with those extracted from the image IMG2 of the camera 52. The same applies to cases in which both the calibration reference and the calibration target are LiDARs 51 or both are cameras 52.

Here, the transformation matrix and coordinate conversion coefficients are, for example, used to convert the coordinate system of the object detection device ODD to be calibrated into that of the reference object detection device ODD. Such a matrix and coefficients can be determined by a known method, and therefore, a detailed description is omitted here.

Next, the specification part 27 or the calibration part of the controller 21 calculates, for example, a degree of coincidence of the same object detected by the object detection device ODD of the calibration target and the object detection device ODD of the calibration reference using the calculated transformation matrix (process P5). Specifically, the specification part 27 or the calibration part extracts, for example, contours of the same object detected by the object detection device ODD of the calibration target and the object detection device ODD of the calibration reference, and calculates the degree of overlap of the contours of the same object on the image data as the degree of coincidence of the same object.

Next, the specification part 27 or the calibration part of the controller 21 determines whether the degree of coincidence of the same object detected by the object detection device ODD to be calibrated and the object detection device ODD to be calibrated is equal to or greater than a threshold (process P6).

In the process P6, when the specification part 27 or the calibration part determines that the degree of coincidence is less than the threshold, that is, not equal to or greater than the threshold (NO), it determines whether a number of repetitions N from the process P3 to the process P6 is equal to or greater than the predetermined value (process P7). Here, the initial value of the number of repetitions N is, for example, 1, and the predetermined value of the number of repetitions N is set to an arbitrary number of times, for example, 3.

In the process P7, when the specification part 27 or the calibration part determines that the number of repetitions N is less than the predetermined value and not equal to or greater than the predetermined value (NO), it adds 1 to the number of repetitions N (process P8). Subsequently, the specification part 27 or the calibration part changes contour or feature point to be associated with the same object detected by the object detection device ODD to be calibrated and the object detection device ODD to be calibrated (process P9). Subsequently, the specification part 27 or the calibration part re-executes the aforementioned processes P3 to P6.

As a result, in the process P6, when the specification part 27 or the calibration part determines that the degree of coincidence of the same object detected by the object detection device ODD to be calibrated and the object detection device ODD to be calibrated is equal to or greater than the threshold (YES), the processing flow shown in FIG. 16 ends. In this case, the controller 21 may, for example, notify via the display part 24 that the calibration of the object detection device ODD to be calibrated has been completed.

Conversely, in the process P6, when it is repeatedly determined that the degree of coincidence is not equal to or greater than the threshold (NO) and the number of repetitions N from the process P3 to the process P6 reaches a predetermined value, the specification part 27 or the calibration part determines that the number of repetitions N is equal to or greater than the threshold (YES) in the process P7. In this case, the specification part 27 or the calibration part terminates the processing flow shown in FIG. 16. In this case, the controller 21 may, for example, notify via the display part 24 that the degree of coincidence between the object detection device ODD to be calibrated and the same object detected by the object detection device ODD to be calibrated is less than the threshold.

Hereinafter, the operation of the perimeter monitoring system for the working machine according to the present embodiment will be described.

Conventionally, in order to perform accurate calibration between a plurality of object detection devices mounted on the working machine, it is necessary to use a special calibration tool such as a calibration board on which a calibration pattern is displayed. However, in order for an on-site worker to perform calibration between a plurality of object detection devices, it is time-consuming and complicated to prepare a calibration tool for each work site where the working machine is used.

In addition, when calibration tools are not prepared at the work site, it is necessary to extract corresponding feature points from object detection results by a plurality of object detection devices, but it is difficult to estimate corresponding feature points among a plurality of object detection devices with different dimensions. Therefore, there is a need for a technology that can facilitate calibration among a plurality of object detection devices without requiring special calibration tools and regardless of the specifications and installation conditions of the object detection devices.

Conversely, the perimeter monitoring system for the working machine of the present embodiment includes a plurality of object detection devices ODDs for detecting objects around the crane 1, which is an example of a working machine, and a controller 21. The controller 21 calibrates at least one other object detection device ODD detachably attached to the crane 1 among the plurality of object detection devices ODDs based on at least one object detection device ODD fixed to the crane 1 among the plurality of object detection devices ODDs.

With this configuration, the perimeter monitoring system for the working machine of the present embodiment can configure the object detection device ODD to be calibrated based on the detection result of the same object detected by the object detection device ODD to be calibrated and the object detection device ODD to be calibrated. That is, since the object detection device ODD to be calibrated is fixed to the crane 1 as a working machine, its coordinate system is known. Therefore, the controller 21 can calibrate by converting the coordinate system of the object detection device ODD to be calibrated into the known coordinate system of the object detection device ODD to be calibrated using the detection result of the same object detected by the object detection device ODD to be calibrated and the object detection device ODD to be calibrated. Therefore, according to the perimeter monitoring system for the working machine of the present embodiment, it is possible to facilitate calibration between a plurality of object detection devices ODDs regardless of the specifications and installation conditions of the object detection devices ODDs without requiring special calibration tools.

Further, in the perimeter monitoring system for the working machine of the present embodiment, the plurality of object detection devices ODDs include a first object detection device ODD fixed to the crane 1 as the working machine, and second and third object detection devices ODDs detachably attached to the crane 1. Moreover, the controller 21 calibrates the second object detection device ODD with reference to the first object detection device ODD, and calibrates the third object detection device ODD with reference to the second object detection device ODD after calibration.

With this configuration, for example, as shown in FIGS. 15A and 15B, it is possible to calibrate the first LiDAR 51a with reference to the first camera 52a fixed to the crane 1, and calibrate the second LiDAR 51b and the third LiDAR 51c with reference to the first LiDAR 51a after calibration. Similarly, as shown in FIGS. 15A and 15C, it is possible to calibrate the second LiDAR 51b and the third LiDAR 51c with reference to the first LiDAR 51a fixed to the crane 1. Furthermore, it is possible to calibrate the second camera 52b with reference to the second LiDAR 51b after calibration, and calibrate the third camera 52c with reference to the third LiDAR 51c after calibration. Therefore, it is possible to readily calibrate a plurality of object detection devices ODDs, even if the positions and attitudes of some object detection devices ODDs are misaligned due to vibration of the crane 1, or disassembly or assembly of the crane 1.

In the perimeter monitoring system for the working machine of the present embodiment, the plurality of object detection devices ODDs may include a fourth object detection device ODD that is different from the first, second, and third object detection devices ODDs described above. In this case, the fourth object detection device ODD may be calibrated based on the third object detection device ODD after calibration, or another fourth object detection device ODD may be calibrated based on the second object detection device ODD after calibration. That is, the plurality of object detection devices ODDs may include, for example, three or more object detection devices ODDs.

Further, in the perimeter monitoring system for the working machine of the present embodiment, the controller 21 acquires detection results of the same object in which a plurality of different postures are taken from the object detection device ODD that is a reference for calibration and the object detection device ODD to be calibrated. Further, the controller 21 extracts the same feature points of the same object and calibrates the object detection device ODD to be calibrated using the same feature points.

With this configuration, the perimeter monitoring system for the working machine of the present embodiment can readily extract detection results of the same object from detection results of the object by the plurality of object detection devices ODDs. Specifically, as shown in FIGS. 17A to 17C, for example, by causing the same object for calibration detected by the plurality of object detection devices ODDs to take a plurality of different postures, detection results of the same object for calibration can be readily specified among detection results of the object by the plurality of object detection devices ODDs. Furthermore, based on the identified different postures of the same object, the perimeter monitoring system for the working machine of the present embodiment readily extracts the same feature points of, for example, the head, feet, and hands.

In the perimeter monitoring system for the working machine of the present embodiment, the plurality of different postures of the same object are the plurality of postures of the same object with different heights.

According to the perimeter monitoring system for the working machine of the present embodiment, the detection result of the same object for calibration can be readily extracted from the detection results of the same object for calibration by the plurality of object detection devices ODDs based on the change in height of the same object for calibration.

Moreover, in the perimeter monitoring system for the working machine of the present embodiment, the object detection device ODD as the calibration reference and the object detection device ODD to be calibrated are installed at different heights.

According to the above configuration, even if the object detection device ODD as the calibration reference and the object detection device ODD to be calibrated have different detection ranges in the height direction of the same object for calibration, the detection result of the same object can be readily extracted based on the change in height of the same object.

As described above, according to the present embodiment, the perimeter monitoring system for the working machine can readily perform calibration between the plurality of object detection devices ODDs.

### Other Application Examples

In the present disclosure, the type of crane is not particularly limited, and in addition to mobile cranes such as crawler cranes, wheel cranes and truck cranes, any crane such as port cranes, ceiling cranes, gate cranes, unloaders and fixed cranes may be included.

In addition, the present disclosure is not limited to the application to a crane as a working machine, but can be applied to other working machines as long as they are working machines. For example, the present disclosure can be applied to working machines such as forklifts, excavators, asphalt finishers, soil improvers, and foundation machines.

In the present disclosure, the installation position of the reference sensor 13 is not limited to the first measurement device mounting part 9 of the upper swivel body 3, but may be arranged on the upper surface of the upper swivel body 3 or the lateral surface of the counterweight 5.

Further, the present invention is not limited to these embodiments, and various variations and modifications may be made without departing from the scope of the present invention.

What is claimed is:

1. A perimeter monitoring system for a working machine, comprising:
a plurality of object detection devices configured to detect an object in a perimeter of the working machine; and
a controller configured to calibrate at least one object detection device detachably attached to the working machine with reference to at least one other object detection device fixed to the working machine, the at least one object detection device and the at least one other object detection device being from among the object detection devices.

2. The perimeter monitoring system for the working machine according to claim 1, comprising:
a first position measurement device configured to measure three-dimensional information of the object; and
a second position measurement device, which is separate from the first position measurement device, configured to measure three-dimensional information of the object, wherein:
the first position measurement device is fixed to a first measurement device mounting part of the working machine;
the second position measurement device is configured to be attachable to a plurality of positions on the working machine; and
the controller includes a processor configured to calibrate a position and an attitude of the second position measurement device with reference to the first position measurement device.

3. The perimeter monitoring system for the working machine according to claim 2, wherein:
measurement ranges of the first position measurement device and the second position measurement device have an overlapping region of at least a partial overlap; and
the processor is configured to calibrate the position and the attitude of the second position measurement device based on an object located in the overlapping region.

4. The perimeter monitoring system for the working machine according to claim 3, wherein the specification part is configured to calibrate the position and the attitude of the second position measurement device based on a person located in the measurement ranges that are overlapping.

5. The perimeter monitoring system for the working machine according to claim 2, comprising:
a lower traveling body; and
an upper swivel body, and configured to:
acquire first three-dimensional information of the object with the first position measurement device; and
acquire second three-dimensional information with the second position measurement device, in a state where the upper swivel body is swiveled by a predetermined angle from a swivel position at which the first three-dimensional information is acquired with the first position measurement device.

6. The perimeter monitoring system for the working machine according to claim 5, wherein at least one of the first position measurement device or the second position measurement device is configured to generate three-dimensional information for use in the specification part from three-dimensional information acquired at two different swivel angles.

7. The perimeter monitoring system for the working machine according to claim 6, wherein:
the first position measurement device and the second position measurement device are configured to measure three-dimensional information of the object by irradiating light with predetermined irradiation patterns; and
the predetermined irradiation patterns of the first position measurement device and the second position measurement device are different.

8. The perimeter monitoring system for the working machine according to claim 1, wherein:
the plurality of object detection devices include:
a first object detection device fixed to the working machine; and
a second object detection device and a third object detection device, the second object detection device and the third object detection device being detachably attached to the working machine, and
the controller is configured to calibrate the second object detection device with reference to the first object detection device, and to calibrate the third object detection device with reference to the second object detection device after the second object detection device has been calibrated.

9. The perimeter monitoring system for the working machine according to claim 8, wherein the controller is configured to acquire detection results of a same object in a plurality of different postures from one of the object detection devices to be a reference of calibration and one of the object detection devices to be calibrated, extract identical feature points of the same object, and calibrate the one of the object detection devices to be calibrated using the identical feature points.

10. The perimeter monitoring system for the working machine according to claim 9, wherein the plurality of different postures of the same object are a plurality of postures of the same object with different heights.

11. The perimeter monitoring system for the working machine according to claim 10, wherein the one of the object detection devices which is configured to be the reference of calibration and the one of the object detection devices to be calibrated are installed at different heights.
